(19) United States
(12) Patent Application Publication
(10) Pub. No.: US 2026/0252841 A1
(43) Pub. Date: Aug. 27, 2026

(54) SYSTEMS AND METHODS FOR GENERATING GRAPH DATA STRUCTURES HAVING DIRECTED AND UNDIRECTED EDGES BASED ON DATASETS

(71) Applicant: EYGS LLP, London (GB)

(72) Inventors: Nandakumar PADMANABHAN, Bangalore (IN); Pranitha V. NAIR, Bangalore (IN); Malini SHANMUGASUNDARAM, Bangsar (MY)

(21) Appl. No.: 19/062,162

(22) Filed: Feb. 25, 2025

(51) Int. Cl. G06N 3/042

(52) U.S. Cl. CPC G06N 3/042

(57) ABSTRACT

A method includes providing a semantic vector data as input to a first graph neural network to produce first prediction data for a first time, the first graph neural network including a graph data structure that has (1) a directed edge having a correlation weight and (2) an undirected edge having a causal weight, and the first graph neural network being configured to generate a first aggregation value based on a plurality of weight values associated with a plurality of nodes of the graph data structure. The semantic vector data is provided as input to a second graph neural network to produce second prediction data for a second time, the second graph neural network being produced based on the graph data structure and configured to generate a second aggregation value based on (1) the plurality of weight values and (2) a temporal dependency.

### FIELD

One or more embodiments described herein relate to systems and computerized methods for generating forecasts based on graph data structures having directed and undirected edges.

### BACKGROUND

A need exists for predicting outcomes that involve multiple entities having different relationships between them. A further need exists for predicting these outcomes for a series of times (e.g., successive years).

### SUMMARY

According to an embodiment, a non-transitory, processor-readable medium stores instructions that, when executed by a processor, cause the processor to receive a plurality of datasets and defining, within a graph data structure, a plurality of nodes based on the plurality of datasets, each node from the plurality of nodes being associated with a dataset from the plurality of datasets. An edge metric value is calculated based on a first node from the plurality of nodes and a second node from the plurality of nodes, and an edge between the first node and the second node is defined based on the edge metric value. A first machine learning model is generated based on the graph data structure that includes the first node, the second node, and the edge, the first machine learning model being configured to generate a first aggregation value (1) based on a plurality of weight values associated with the first node and the second node and (2) not based on a temporal dependency. The instructions further cause the processor to receive input data from a user compute device. At a first time, the input data is provided as input to the first machine learning model to produce first prediction data for a second time that is after the first time. A second machine learning model is generated based on the graph data structure, the second machine learning model being configured to generate a second aggregation value based on the plurality of weight values and the temporal dependency. The input data is provided as input to the second machine learning model to produce second prediction data for a third time that is after the second time.

According to an embodiment, a method includes receiving input data and providing the input data as input to an encoder model to produce semantic vector data. The semantic vector data is provided as input to a first graph neural network to produce first prediction data for a first time, the first graph neural network including a graph data structure that has (1) a directed edge having a correlation weight and (2) an undirected edge having a causal weight, and the first graph neural network being configured to generate a first aggregation value (1) based on a plurality of weight values associated with a plurality of nodes of the graph data structure and (2) not based on a temporal dependency. The semantic vector data is provided as input to a second graph neural network to produce second prediction data for a second time after the first time, the second graph neural network being produced based on the graph data structure and configured to generate a second aggregation value based on (1) the plurality of weight values and (2) the temporal dependency.

According to an embodiment, a non-transitory, processor-readable medium stores instructions that, when executed by a processor, cause the processor to receive a plurality of datasets and determine a plurality of features based on the plurality of datasets. The instructions further cause the processor to define, within a graph data structure, a plurality of nodes based on the plurality of features. A first edge metric value is calculated based on a first node from the plurality of nodes and a second node from the plurality of nodes, and an undirected edge between the first node and the second node is defined based on the first edge metric value. A second edge metric value is calculated based on a third node from the plurality of nodes and a fourth node from the plurality of nodes, and a directed edge between the third node and the fourth node is defined based on the second edge metric value. The instructions further cause the processor to generate a graph neural network (GNN) configured to generate first prediction data for a first time, based on the graph data structure that includes the first node, the second node, the third node, the fourth node, the undirected edge, and the directed edge. A temporal graph neural network (TGNN) configured to generate second prediction data for a second time that is after the first time is generated based on the graph data structure.

### BRIEF DESCRIPTION OF THE DRAWINGS

FIG. 1 shows a system block diagram of forecasting system, according to an embodiment.

FIG. 2 shows a system block diagram of a compute device included in a forecasting system, according to an embodiment.

FIG. 3 shows a system block diagram of forecasting components included in a forecasting system, according to an embodiment.

FIG. 4 shows a representation of a graph having directed and undirected edges, according to an embodiment.

FIGS. 5A-B show flow diagrams illustrating a method implemented by a forecasting system to generate prediction data for multiple times, according to an embodiment.

FIG. 6 shows a flow diagram illustrating a method implemented by a forecasting system to produce prediction data using graph neural networks, according to an embodiment.

FIGS. 7A-B show flow diagrams illustrating a method implemented by a forecasting system to generate graph neural networks and temporal graph neural networks, according to an embodiment.

### DETAILED DESCRIPTION

At least some systems and methods described herein model multiple entities and their relationships using graph data structures having directed and undirected edges, such that graph neural networks (GNNs) and temporal graph neural networks (TGNNs) can generate predictions for a series of times. As described further herein, a graph having both directed and undirected edges can represent complex relationships between a plurality of entities and/or components, including hierarchical relationships, causal relationships, and/or correlated relationships. Moreover, a GNN and/or TGNN associated with graph having both directed and undirected can facilitate both unidirectional message passing (along directed edges) and bidirectional message passing (along undirected edges). As a result, the GNN and/or TGNN can generate predictions for more complex systems as compared to a GNN and/or TGNN associated with a graph having either directed or undirected edges (but not both).

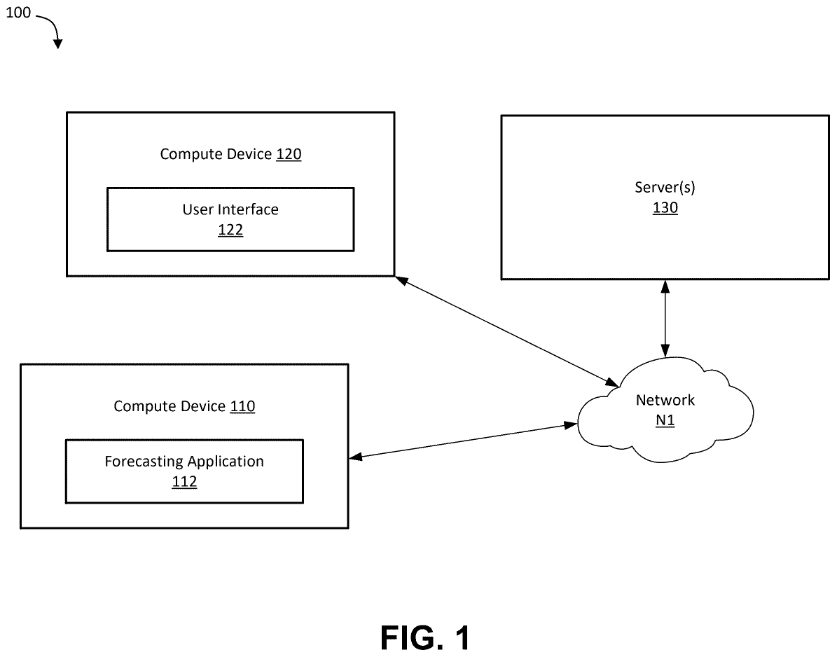

FIG. 1 shows a system block diagram of a forecasting system 100, according to an embodiment. The forecasting system 100 includes a compute device 110, a compute device 120, a database server(s) 130, and a network N1. The forecasting system 100 can include alternative configurations, and various steps and/or functions of the processes described below can be shared among the various devices of the forecasting system 100 or can be assigned to specific devices (e.g., the compute device 110, the compute device 120, and/or the like) different from the descriptions herein. For example, in some configurations, a user can provide inputs directly to the compute device 110 rather than via the compute device 120, as described herein.

In some implementations, the compute device 110, the compute device 120, and/or the database server(s) 130 can include any suitable hardware-based computing devices and/or multimedia devices, such as, for example, a server, a desktop compute device, a smartphone, a tablet, a wearable device, a laptop and/or the like. In some implementations, the compute device 110, the compute device 120, and/or the database server(s) 130 can be implemented at an edge (e.g., with respect to the network N1) node or other remote (e.g., with respect to the network N1) computing facility and/or device. In some implementations, each of the compute device 110, the compute device 120, and/or the database server(s) 130 can be (or be included in) a data center or other control facility and/or device configured to run and/or execute a distributed computing system and can communicate with other compute devices.

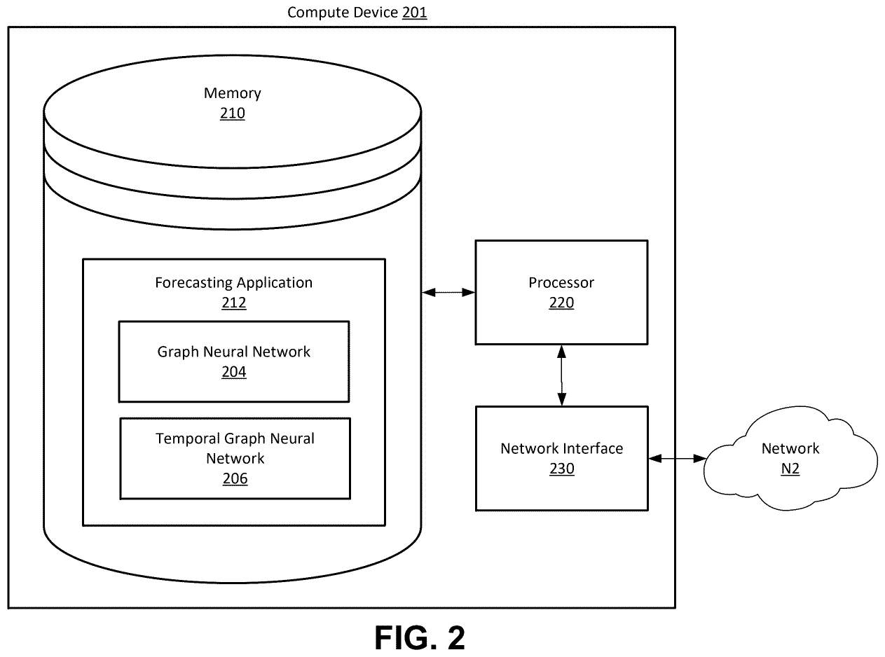

The compute device 110 can include a forecasting application 112, which can include software (1) stored at a memory that is functionally and/or structurally similar to the memory 210 of FIG. 2 discussed below and (2) executed via a processor that is functionally and/or structurally similar to the processor 220 of FIG. 2 discussed below. The forecasting application 112 can be configured to generate predictions based on graph data structures for multiple times that are later than the time of generating the predictions, as described further herein.

The compute device 120 can implement a user interface 122, which can include a graphical user interface (GUI) (e.g., displayed on a monitor/display) that is configured to receive input data (e.g., user input data, described further herein) from a user. The user interface 122 can further cause display of output data generated by the forecasting application 112 (e.g., prediction data, described further herein). The user interface 122 can be implemented via software and/or hardware.

The database server(s) 130 can implement a database, which can include a collection of data (e.g., a dataset) configured for retrieval and storage. More specifically, the database server(s) can, for example, execute database management software such as, for example, MySQL, PostgreSQL®, MongoDB®, and/or the like. In some instances, the database can be configured for semantic search.

The compute device 110 can be networked and/or communicatively coupled to the compute device 120 and/or the database server(s) 130, via the network N1, using wired connections and/or wireless connections. The network N1 can include various configurations and protocols, including, for example, short range communication protocols, Bluetooth®, Bluetooth® LE, the Internet, World Wide Web, intranets, virtual private networks, wide area networks, local networks, private networks using communication protocols proprietary to one or more companies, Ethernet, WiFi® and/or Hypertext Transfer Protocol (HTTP), cellular data networks, satellite networks, free space optical networks and/or various combinations of the foregoing. Communication can be facilitated by any device capable of transmitting data to and from other compute devices, such as a modem(s) and/or a wireless interface(s).

In some implementations, although not shown in FIG. 1, the forecasting system 100 can include multiple compute devices 110, compute devices 120, and/or servers 130. For example, in some implementations, the forecasting system 100 can include multiple compute devices 110, where each compute device 110 can be associated with a different user from multiple users. In some implementations, multiple compute devices 110 can be associated with a single user, where each compute device 110 can be associated with, for example, a different input modality (e.g., text input, audio input, video input, etc.). Some implementations can include various combinations of the above.

FIG. 2 shows a system block diagram of a compute device 201 included in a forecasting system, according to an embodiment. The compute device 201 can be structurally and/or functionally similar to, for example, the compute device 110 and/or 120 and/or the database server(s) 130 of the forecasting system 100 shown in FIG. 1. The compute device 201 can be a hardware-based computing device, a multimedia device, or a cloud-based device such as, for example, a computer device, a server, a desktop compute device, a laptop, a smartphone, a tablet, a wearable device, a remote computing infrastructure, and/or the like. The compute device 201 includes a memory 210, a processor 220, and a network interface 230 operably coupled to a network N2.

The processor 220 can be, for example, a hardware-based integrated circuit (IC), or any other suitable processing device configured to run and/or execute a set of instructions or code (e.g., stored in memory 210). For example, the processor 220 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a graphics processing unit (GPU), a programmable logic controller (PLC), a remote cluster of one or more processors associated with a cloud-based computing infrastructure and/or the like. The processor 220 is operatively coupled to the memory 210. In some embodiments, for example, the processor 220 can be coupled to the memory 210 through a system bus (for example, address bus, data bus and/or control bus). In some implementations, the processor 220 can include multiple parallelly arranged processors.

The memory 210 can be, for example, a random-access memory (RAM), a memory buffer, a hard drive, a read-only memory (ROM), an erasable programmable read-only memory (EPROM), and/or the like. The memory 210 can store, for example, one or more software modules and/or code that can include instructions to cause the processor 220 to perform one or more processes, functions, and/or the like. In some implementations, the memory 210 can be a portable memory (e.g., a flash drive, a portable hard disk, and/or the like) that can be operatively coupled to the processor 220. In some instances, the memory can be remotely operatively coupled with the compute device 201, for example, via the network interface 230. For example, a remote database server can be operatively coupled to the compute device 201.

The memory 210 can store various instructions associated with processes, algorithms and/or data, as described herein. Memory 210 can further include any non-transitory computer-readable storage medium for storing data and/or software that is executable by processor 220, and/or any other medium which may be used to store information that may be accessed by processor 220 to control the operation of the compute device 201. For example, the memory 210 can store data associated with a forecasting application 212. The forecasting application 212 can be functionally and/or structurally similar to the forecasting application 112 of FIG. 1 and can be configured to generate predictions based on graph data structures for a plurality of times that are later than the time of generating the predictions, as described further herein.

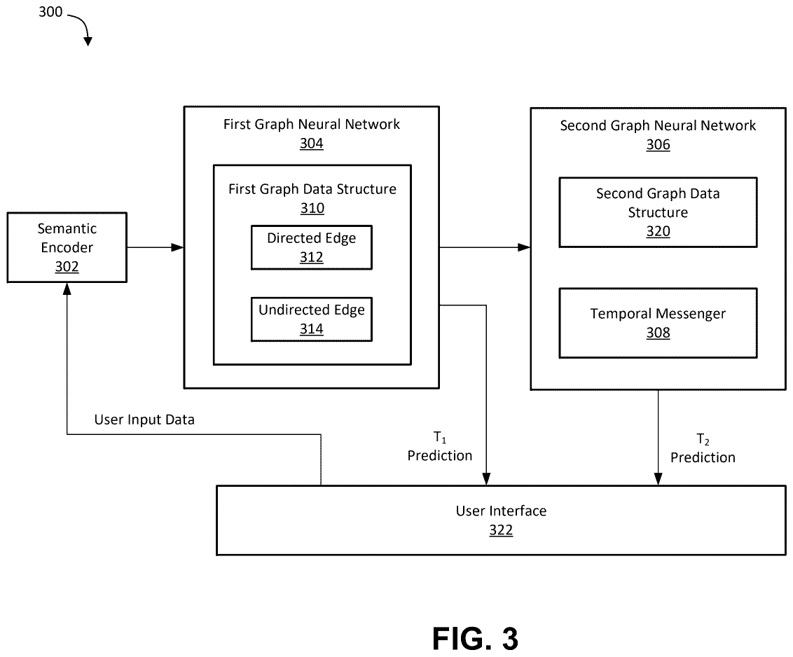

The forecasting application 212 includes a graph neural network 204, which can be functionally and/or structurally similar to the first graph neural network 304 of FIG. 3, which is described further herein. The forecasting application 212 further includes a temporal graph neural network 206, which can be functionally and/or structurally similar to the second graph neural network 306 of FIG. 3, which is described further herein.

The network interface 230 can be configured to connect to the network N2, which can be functionally and/or structurally similar to the network N1 of FIG. 1. For example, network N2 can use any of the communication protocols described above with respect to network N1 of FIG. 1. In some implementations, the network interface 230 can include a network interface controller (NIC) that implements a physical and/or data link layer (e.g., Ethernet, Wi-Fi, etc.).

In some instances, the compute device 201 can further include a display, an input device, and/or an output interface (not shown in FIG. 2). The display can be any display device (e.g., a monitor, screen, etc.) by which the compute device 201 can output and/or display data (e.g., via a user interface that is structurally and/or functionally similar to the user interface 122 of FIG. 1). The input device can include, for example, a mouse, keyboard, touch screen, voice interface, and/or any other hand-held controller or device or interface via which a user may interact with the compute device 201. The output interface can include, for example, a bus, port, and/or other interfaces by which the compute device 201 may connect to and/or output data to other devices and/or peripherals.

FIG. 3 shows a system block diagram of forecasting components included in a forecasting system, according to an embodiment. The forecasting components 300 can be associated with a compute device (e.g., a compute device that is structurally and/or functionally similar to the compute device 201 of FIG. 2 and/or the compute devices 110 and 120 of FIG. 1). For example, the forecasting components 300 can be included in and/or associated with (1) the forecasting application 112 of FIG. 1 and/or (2) the forecasting application 212 of FIG. 2. In some instances, the forecasting components 300 can include software stored in memory 210 and configured to execute via the processor 220 of FIG. 2. In some instances, at least a portion of the forecasting components 300 can be implemented in hardware (e.g., an ASIC) or a combination of hardware and software.

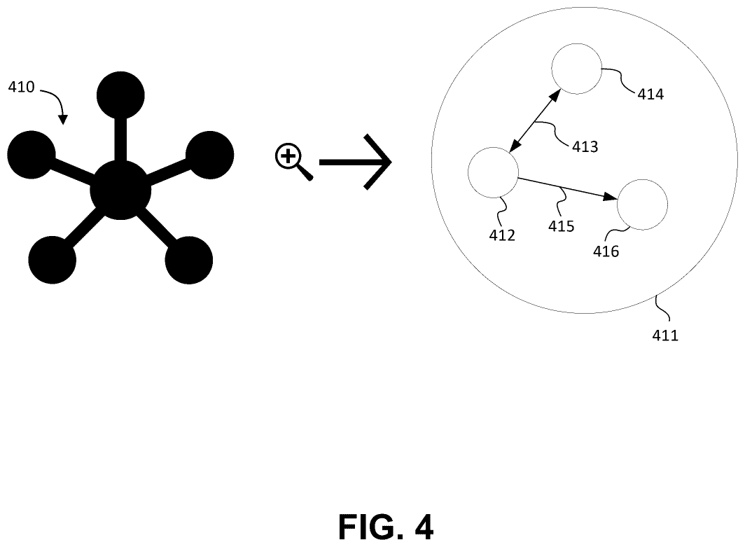

The forecasting components 300 include a user interface 322 (e.g., that is functionally and/or structurally similar to the user interface 122 of FIG. 1), a semantic encoder 302, a first graph neural network (GNN) 304, and a second GNN 306. The first GNN 304 includes a first graph data structure 310 (e.g., that is functionally and/or structurally similar to the graph 410 of FIG. 4), and the second GNN 306 includes a second graph data structure 320 (e.g., that is functionally and/or structurally similar to the graph 410 of FIG. 4).

The user interface 322 can include a graphical user interface (GUI), a programmatic user interface, and/or the like, that is configured to receive user input data from a user to inform a prediction. A prediction can include, for example, a prediction of the total cost of ownership (TCO) associated with adoption of a cloud-based information technology infrastructure. The user input data can include, for example, parameters, requirements, constraints, etc., that inform a prediction(s) generated by the forecasting components 300. The user input data can also define at least one entity (e.g., department, organization, device, etc.) associated with (e.g., responsible for defining) the parameters, requirements, constraints, etc. In some implementations, the user input data can include a document that indicates the entities and associated parameters, requirements, constraints, etc., as described further herein. The semantic encoder 302 can receive the user input data and, in response, generate a semantic vector(s) (e.g., classification data that represents a semantic meaning of the user input data). The first GNN 304 can then receive the semantic vector(s) as input to generate T₁ prediction data, as described in further detail below.

The first GNN 304 includes the first graph data structure 310, which includes a directed edge 312 (e.g., that is functionally and/or structurally similar to the directed edge 415) and an undirected edge (e.g., that is functionally and/or structurally similar to the undirected edge 413). As described further below, the first graph data structure 310 can represent a knowledge graph (KG) that includes nodes produced from the semantic vectors produced by the semantic encoder 302. Alternatively or in addition, nodes within a KG can be defined based on historical data (e.g., data not received via the user interface 322 but relevant (or potentially relevant) to the predictions to be generated). Historical data can include, for example, a cost of a cloud service configuration, a total cost of ownership for a similarly situated user to the user providing prediction related data to the user interface 322, etc.

In some instances, a KG can be produced from and/or represent corpus data to facilitate predictions for multiple times (e.g., for multiple future years). More specifically, a KG can represent interlinking entities, relationships, and temporal dynamics in an interconnected semantic framework. For example, a KG can leverage temporal reasoning and pattern recognition to extrapolate future outcomes by analyzing historical trends, current states, and potential future states of entities. Further, using time-series forecasting, a KG can dynamically adjust predictions based on new data inputs, maintaining a continuously updated and accurate predictive model. By leveraging unstated connections across different time frames and parameters (e.g., in addition to or instead of leveraging direct relationships), a KG can facilitate more realistic and personalized optimizations for multi-year forecasts.

To construct the KG, data can be collected and aggregated from multiple sources. This data can include, for example, financial data (e.g., revenue, expenses, profit margins, etc.), business performance data (e.g., key performance indicators (KPIs), productivity metrics, sales figures, etc.), on-premises costs data (e.g., operational costs, maintenance expenses, etc.), historical data (past financial and/or performance records, economic indicators, etc.), and/or the like. The aggregated data can be normalized through preprocessing steps (e.g., preformed by a preprocessor, not shown in FIG. 3) to standardize each feature to have zero mean and unit variance (e.g., by computing, where Xᵢ=xᵢ−muᵢ/sigmaᵢ, where Xᵢ is the standardized value, xᵢ is the original value, muᵢ is the mean of a distribution that includes xᵢ, and sigmaᵢ is the standard deviation of that distribution). In some implementations, missing value imputation (e.g., mean imputation, regression imputation, etc.) can be performed (e.g., by the preprocessor) to fill in incomplete or omitted data within the aggregated data, producing augmented data. Feature selection can also be performed (e.g., by the preprocessor configured to perform principal component analysis (PCA)) to identify significant features.

The KG includes multiple nodes, and each node can represent a feature identified by the data preprocessing describe above. Examples of nodes can include, for example, financial metrics nodes (N_{Fd}) (e.g., revenue nodes (nᵣₑᵥ), expense nodes (nₑₓₚ), profit margin nodes (nₚₘ), etc.), business unit nodes (N_{Bd}) (e.g., sales department nodes (nₛₐₗₑₛ), marketing department nodes (nₘₖₜ), etc.), cost center nodes (N_{Cd}), operational cost nodes (nₒₚ), maintenance cost nodes (nₘₐᵢₙₜ), etc.), historical event nodes (N_{Hd}) (e.g., economic downturn nodes (n_{eco}), market trend nodes (n_{trend}), etc.).

The prediction system (or another system configured to construct knowledge graphs) can be configured generate different types of edges to define different types of relationships between nodes. For example, a directed edge can define a causal relationship between nodes (e.g., to indicate that increased marketing spend leads to higher sales). An undirected edge can define a statistical correlation between nodes. In some instances, edges can also represent hierarchical relationships to define an organizational structure, as exemplified further herein.

To determine an edge, the prediction system (or another system configured to construct knowledge graphs) can be configured to compute, for each node pair (nᵢ, nⱼ), a correlation metric (e.g., a correlation coefficient, such as a Pearson correlation coefficient pᵢⱼ=cov(xᵢ, xⱼ)/{sigma xᵢ*sigma xⱼ}, where cov(xᵢ, xⱼ) is the covariance between features xᵢ & xⱼ, and sigma is the standard deviation). Based on the correlation metric, the prediction system can determine whether to establish an edge. For example, an edge can be established if the correlation metric exceeds (or crosses) a predetermined threshold T (e.g., if |pᵢⱼ|>\T (a predetermined threshold), create an edge eᵢⱼ between nᵢ and nⱼ). To define a causal relationship, the prediction system can be configured to perform a causality test (e.g., a Granger causality tests, structural equation modeling, etc.).

In some implementations, a feature vector can represent a node, and an adjacency matrix can represent edges (e.g., connections) between nodes. For example, for a given node pair that does not have a defined edge between the nodes of the node pair, the adjacency matrix can have a zero-value element. Otherwise, for a node pair that has a defined edge, the adjacency matrix can include a non-zero edge weight value for that node pair. Alternatively, the adjacency matrix can include a one value to indicate that the node pair has a defined edge, and an addition edge weight matrix can include the edge weight value for that edge. An edge weight can indicate a strength of a relationship between nodes (e.g., as determined by the correlation metric and/or the causality test). Summarizing the above, the first graph data structure 310 can include a feature vector for each node, an adjacency matrix, and/or an edge weight matrix.

Referring now to the first GNN 304 in use (e.g., during inferencing), the first graph data structure 310 can have initialized node embeddings (e.g., with initial values hᵢ⁽⁰⁾=xᵢ, based on a previous (e.g., most recent) observation). The first GNN 304 can be configured to compare data between nodes (referred to herein as message passing), such that the first GNN 304 can aggregate data between nodes. More specifically, for each node nᵢ and layer 1, the first GNN 304 can determine the following:

$${m}_{i}^{( l )} = \backslash {sum}_{j ε N ( i )} {W}_{E}^{( l )} * {h}_{j}^{( l - 1 )}$$

where _{N(i)} is the set of neighboring nodes of nᵢ, and W_{E}^{(l)} is the weight matrix for edges at layer l.

The first GNN 304 can then update node embeddings by applying an activation function (e.g., a linear activation function, a ReLu activation function, a Heaviside activation function, etc.). By applying the activation function, the first GNN 304 can calculate the output of each node within the first graph data structure 310. The application of the activation function is represented by the following:

$${h}_{i} ( l ) = sigma ( {W}^{( l )} * {m}_{i}^{( l )} + {b}^{( l )} )$$

where sigma is an activation function (e.g., ReLU, etc.), and W^{(l)} and b^{(l)} are learnable parameters.

The first GNN 304 can then aggregate each node output to generate a prediction for time T₁ (e.g., Year 1), as shown by the following:

$${h}_{g r a p h} = \{ READOUT \} ( \{ {h}^{( L )} \vert {n}_{{i}_{ε}} N \} )$$

$${T}_{1} = fMLP ( {h}_{graph} )$$

where fMLP is a Multi-Layer Perceptron.

In some implementations, the first GNN 304 can be configured to perform a loss calculation and optimization to cause a weight(s) of the first GNN 304 to be modified in response to receiving additional data from the user via the user input 322. Weight modification is described further below in relation to the second GNN 306.

The second GNN 306 can be configured to generate a prediction for a second time T₂ (e.g., Year 2, Year 3, Year 4, etc.) that is after time T₁ associated with the prediction generated by the first GNN 304. As compared to the first GNN 304, the second GNN 306 can be configured to consider temporal dynamics and increased uncertainty, given that the second GNN 306 generates prediction for times further in the future than predictions generated by the first GNN 304.

The second GNN 306 can include a temporal graph neural network (TGNN) that incorporates time-dependent features xᵢ^{(t)}. More specifically, the second GNN 306 can be modified from the first GNN 304 to perform temporal message passing. The second GNN 306 can include the second graph data structure 320, which can be substantially similar to the first graph data structure 310. In some implementations, the second graph data structure 320 can be a separate instance (e.g., a copy) of the first graph data structure 310. Alternatively, the second graph data structure 320 can be the first graph data structure 310, such that the first GNN 304 and the second GNN 306 operate on the same graph data structure. For example, after producing the T₁ prediction, the first GNN 304 can be automatically modified to facilitate temporal message passing, producing the second GNN 306. More specifically, the second GNN 306 can be configured to model a temporal dimension, analyzing data through time to capture sequential dependencies. The second GNN 306 can moreover incorporate lag features, moving averages, and/or time-based encoding.

In some implementations, as described further below, the forecasting components 300 can be configured to incorporate new data by updating nodes and edges within the first graph data structure 310 and/or the second graph data structure 320, as new data arrives. The forecasting components 300 can further adjust model weights within the first GNN 304 and/or the second GNN 306 by retraining and/or fine-tuning the model(s) to reflect newly received data (e.g., via the user interface 322). As a result, prediction accuracy can be improved. The second GNN 306 can be further configured to predict future values by adjusting for temporal dependencies using historical trend data.

Updating a KG to adjust predictions involves the following steps. First, the forecasting system ingests fresh data (e.g., for a latest time period t). This new data can include, for example, financial data, business performance metrics, cost data, etc., for that time period t. This fresh data can be preprocessed (e.g., using the normalization process described above), and the semantic encoder 302 can extract semantic features from the normalized fresh data. If a new (e.g., previously unrepresented) entity is detected within these semantic features, a new node representing this new entity is added to the KG. For existing nodes, the feature vectors Xᵢ(t) of the existing nodes can be updated based on the semantic features extracted from the normalized fresh data. In some instances, the fresh data can indicate that an entity is to be removed from the prediction (e.g., as a result of downsizing, consolidation, etc.), and the node associated with the entity can be automatically removed from the KG in response. Relationships between and/or involving new and/or updated nodes can be recalculated (based on recalculated correlation and/or causation metrics, as described above), and edges can be modified (e.g., added and/or removed) based on added and/or removed nodes. Edge weights can also be recalculated based on the recalculated correlation and/or causation metrics.

In some instances, the second GNN 306 can dynamically adjust its weights based on incoming time-series data. For example, the second GNN 306 can have initial node embeddings hi^{(o)}(t₀)=Xₜ(t₀) defined for an initial time t₀ from time steps T={t₀, t₁, t₂, . . . , tₙ}. The second GNN 306 can then perform temporal message passing for each subsequent time step based on the following:

$${m}_{i}^{l} ( t ) = {Sigma}_{j ε N ( i )} {W}_{E}^{( l )} ( t ) * {h}_{j}^{( l - 1 )} ( t - delta ( t ) )$$

where delta(t) is the time lag (e.g., the difference between successive time steps) and W_{E}^{(l)}(t) is the weight at layer l and time t.

The second GNN 306 can then update node statuses based on the following:

$${H}_{i}^{( l )} ( t ) = Sigma ( {W}^{( l )} ( t ) * {m}_{i}^{( l )} ( t ) + {b}^{( l )} ( t ) )$$

where W^{(l)}(t) and b^{(l)}(t) are learnable parameters for a time t.

Once node statuses are updated, a machine learning model and/or layer (e.g., a long-term short-term model/layer, a temporal convolutional network/layer, and/or the like) can process each node to perform a time series forecast, producing a forecasted node embedding for each node. An output layer can then aggregate the forecasted node embeddings and apply a machine learning model/layer (e.g., a multi-layer perceptron (MLP)) to the resulting aggregate to output an overall prediction. A backpropagation through time (BPTT) technique can then be used to adjust weights and/or biases of the second GNN 306 based on a loss function (e.g., gradient loss).

To illustrate the forecasting components 300 in use, two entities in a hierarchical relationship can include, for example, a first entity and a second entity. In the context of developing a cloud business case, the first entity can develop a financial document that contains financial guidelines (e.g., budget allocation), budget constraints, return on investment (ROI), and/or the like, for a cloud migration project. With respect to the hierarchical relationship, the first entity can be above the second entity within the hierarchy. The first entity can therefore issue the financial document to serve as a financial blueprint for the cloud migration project, establishing parameters within which the second entity is expected to operate.

The second entity can receive the financial document from the first entity and, based on the financial document, can evaluate and adjust the technical scope of the migration project to fit within the provided budget. The second entity can further analyze costs related to different cloud providers and/or service options to ensure that the financial goals set by the first entity are met. The first graph data structure 310 and/or the second graph data structure 320 can represent (1) the first entity and the second entity with respective nodes and (2) the associated relationship between the first entity and the second entity with a directed edge. Here, the directed edge represents a flow of information and authority from the first entity to the second entity. The semantic encoder 302 can be configured to automatically generate the respective nodes and the directed edge by receiving the financial document as input and recognizing that the financial document is a top-down directive from one entity to another. For example, the semantic encoder 302 can recognize that the financial document provides specific budget constraints, indicating that the first entity has financial oversight over the project and, therefore, a decision-making role above the second entity. Other content that can imply a top-down directive relationship includes financial targets and/or constraints, suggesting that the first entity set strategic goals that the second entity's role is to abide by.

The hierarchical relationship between the node representing the first entity and the node representing the second entity, defined based on the financial document, can inform predictions generated by the first GNN 304 and/or the second GNN 306. For example, parameters (e.g., budget constraints, ROI constraints, etc.) within the financial document can be represented by the feature vector of the first entity node. Cloud service and/or configuration options can be represented by the feature vector of the second entity node. The first GNN 304 can then cause neural messages to flow from the first entity node to the second entity node (e.g., the direction of the directed edge). In some instances, a third entity (e.g., a cloud service) can have a correlated relationship with the second entity, indicating that the second entity has no (or limited) authority over the third entity but that the second entity and/or the third entity can influence decisions between the two.

FIG. 4 shows a representation of a graph 410 having an undirected edge 413 and a directed edge 415, according to an embodiment. Graph portion 411 represents an isolated (e.g., “close up”) portion of the graph 410, showing nodes 412, 414, and 416 of the graph 410. Graph portion 411 further shows (1) the undirected edge 413 coupled to nodes 412 and 414 and (2) the directed edge 415 coupled to nodes 412 and 416.

As described at least in relation to FIG. 3, the undirected edge 413 can indicate that the nodes 412 and 414 are correlated (e.g., the nodes 412 and 414 define a correlation metric that exceeds (or crosses over) a predetermined threshold). The directed edge 415 can indicate that the nodes 412 and 416 are related causally (e.g., the nodes 412 and 416 define a causation metric that exceeds (or crosses over) a predetermined threshold). To illustrate, the node 412 can have a causal relationship over node 416 (e.g., indicating a degree of authority by node 412 over node 416), and the node 412 can have a correlated relationship over node 416 (e.g., indicating a degree of bilateral influence between the node 412 and the node 414). As a result, neural messages can flow from node 412 to node 416 (e.g., but not from node 416 to node 412), and messages can flow in both directions between nodes 412 and 414. In some instances, the undirected edge 413 and/or the directed edge 415 can have an edge weight(s) to indicate a degree of influence by one node over another, adjusting aggregation between nodes based on the degree of correlation and/or causation.

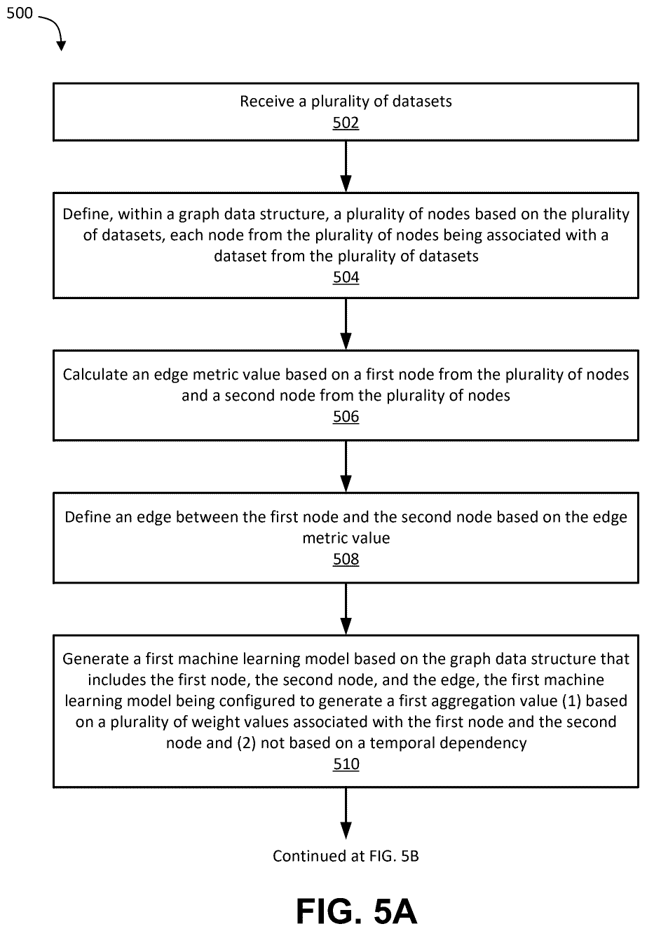

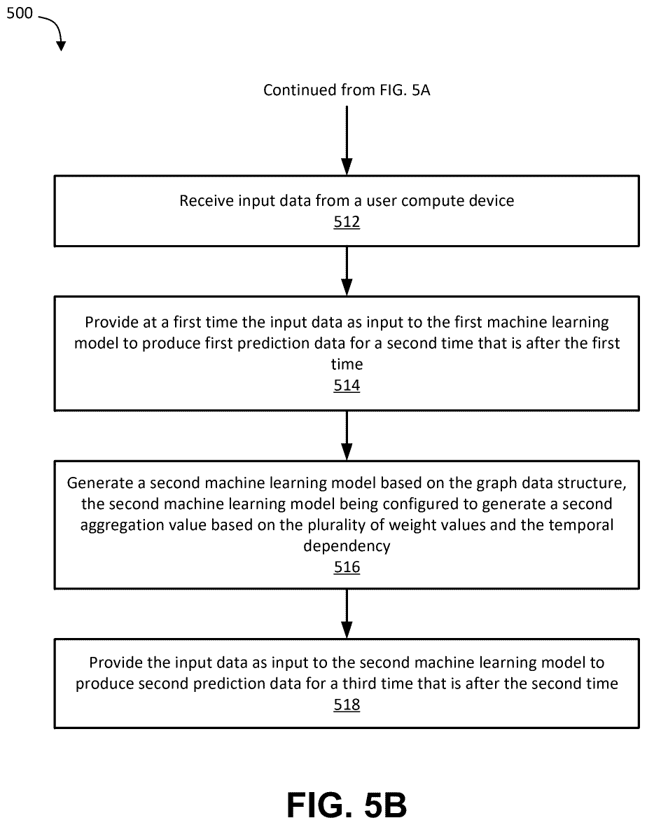

FIGS. 5A-B show flow diagrams illustrating a method 500 implemented by a forecasting system to generate prediction data for multiple times, according to an embodiment. The method 500 can be implemented by a forecasting system described herein (e.g., the forecasting system 100 of FIG. 1). Portions of the method 500 can be implemented using a processor (e.g., the processor 220 of FIG. 2) of any suitable compute device (e.g., the compute device 201 of FIG. 2 and/or the compute devices 110 and/or 120 and/or the database server(s) 130 of FIG. 1).

The method 500 at 502 includes receiving a plurality of datasets and, at 504, defining, within a graph data structure (e.g., first graph data structure 310 of FIG. 3), a plurality of nodes based on the plurality of datasets, each node from the plurality of nodes being associated with a dataset from the plurality of datasets. An edge metric value is calculated at 506 based on a first node from the plurality of nodes and a second node from the plurality of nodes, and an edge (e.g., directed edge 312 or undirected edge 314 of FIG. 3) between the first node and the second node is defined at 508 based on the edge metric value. A first machine learning model (e.g., first GNN 304 of FIG. 3) is generated at 510 based on the graph data structure that includes the first node, the second node, and the edge, the first machine learning model being configured to generate a first aggregation value (1) based on a plurality of weight values associated with the first node and the second node and (2) not based on a temporal dependency. The method 500 at 512 further includes receiving input data from a user compute device. At 514, at a first time, the input data is provided as input to the first machine learning model to produce first prediction data for a second time that is after the first time. A second machine learning model (e.g., second GNN 306 of FIG. 3) is generated at 516 based on the graph data structure, the second machine learning model being configured to generate a second aggregation value based on the plurality of weight values and the temporal dependency. The input data is provided as input to the second machine learning model at 518 to produce second prediction data for a third time that is after the second time.

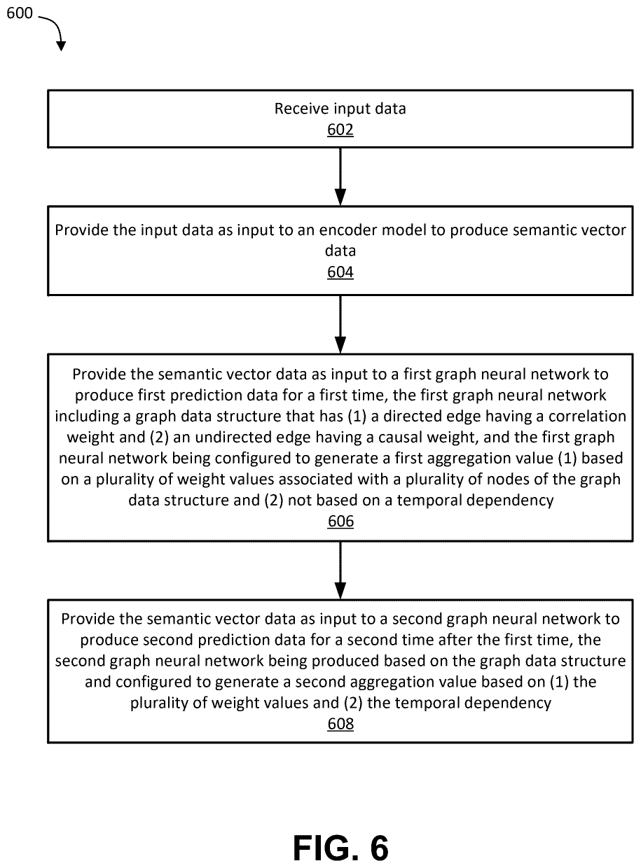

FIG. 6 shows a flow diagram illustrating a method 600 implemented by a forecasting system to produce prediction data using graph neural networks, according to an embodiment. The method 600 can be implemented by a forecasting system described herein (e.g., the forecasting system 100 of FIG. 1). Portions of the method 600 can be implemented using a processor (e.g., the processor 220 of FIG. 2) of any suitable compute device (e.g., the compute device 201 of FIG. 2 and/or the compute devices 110 and/or 120 and/or the database server(s) 130 of FIG. 1).

The method 600 at 602 includes receiving input data and, at 604, providing the input data as input to an encoder model (e.g., semantic encoder 203 of FIG. 3) to produce semantic vector data. The semantic vector data is provided as input to a first graph neural network (e.g., first GNN 304 of FIG. 3) at 606 to produce first prediction data for a first time, the first graph neural network including a graph data structure (e.g., first graph data structure 310 of FIG. 3) that has (1) a directed edge (e.g., directed edge 312 of FIG. 3) having a correlation weight and (2) an undirected edge (e.g., undirected edge 314 of FIG. 3) having a causal weight, and the first graph neural network being configured to generate a first aggregation value (1) based on a plurality of weight values associated with a plurality of nodes of the graph data structure and (2) not based on a temporal dependency. The semantic vector data is provided as input to a second graph neural network (e.g., second GNN 306 of FIG. 3) at 608 to produce second prediction data for a second time after the first time, the second graph neural network being produced based on the graph data structure and configured to generate a second aggregation value based on (1) the plurality of weight values and (2) the temporal dependency.

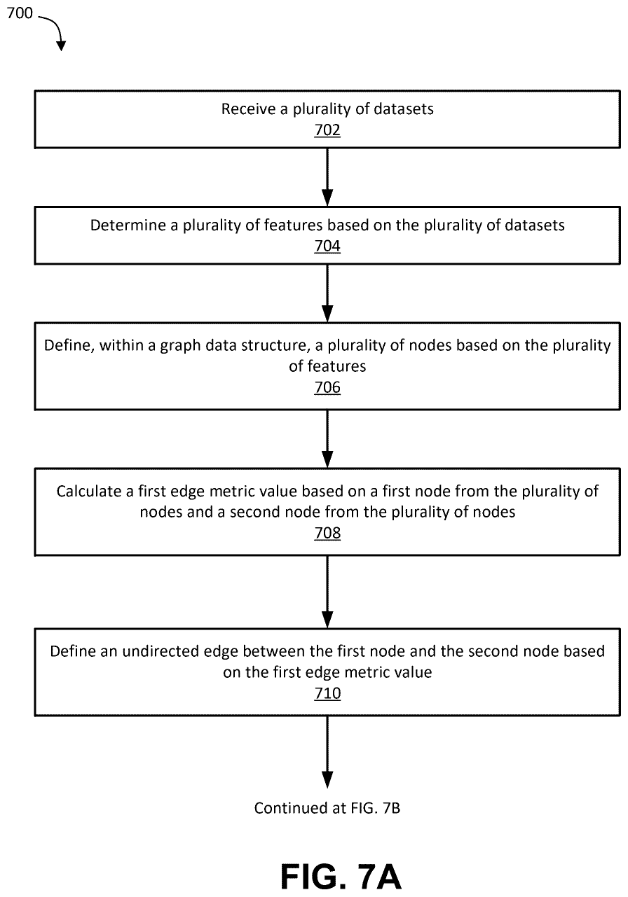

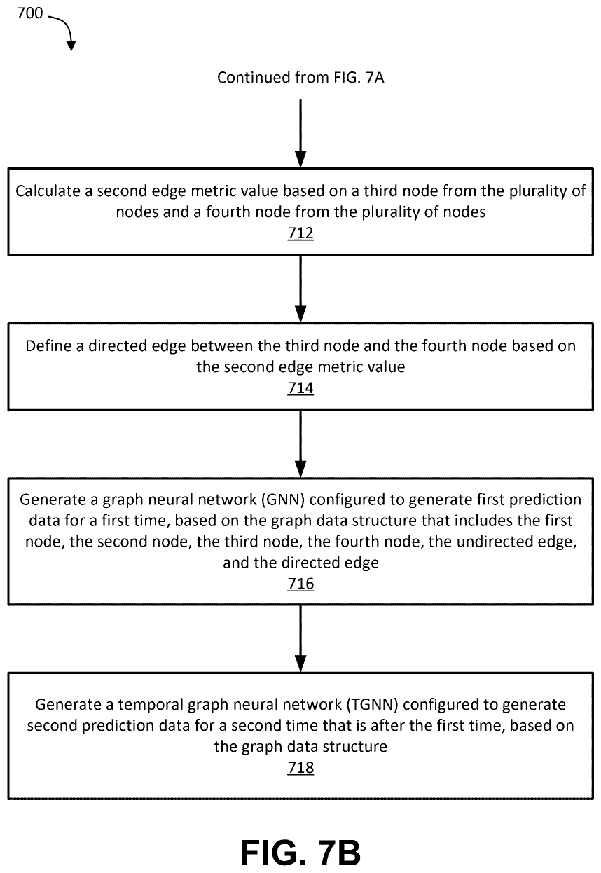

FIGS. 7A-B show flow diagrams illustrating a method 700 implemented by a forecasting system to generate graph neural networks and temporal graph neural networks, according to an embodiment. The method 700 can be implemented by a forecasting system described herein (e.g., the forecasting system 100 of FIG. 1). Portions of the method 700 can be implemented using a processor (e.g., the processor 220 of FIG. 2) of any suitable compute device (e.g., the compute device 201 of FIG. 2 and/or the compute devices 110 and/or 120 and/or the database server(s) 130 of FIG. 1).

The method 700 at 702 includes receiving a plurality of datasets and, at 704, determining a plurality of features based on the plurality of datasets. At 706, the method 700 includes defining, within a graph data structure (e.g., first graph data structure 310 of FIG. 3), a plurality of nodes based on the plurality of features. A first edge metric value is calculated at 708 based on a first node from the plurality of nodes and a second node from the plurality of nodes, and an undirected edge (e.g., undirected edge 314 of FIG. 3) between the first node and the second node is defined at 710 based on the first edge metric value. A second edge metric value is calculated at 712 based on a third node from the plurality of nodes and a fourth node from the plurality of nodes, and a directed edge (e.g., directed edge 312 of FIG. 3) between the third node and the fourth node is defined at 714 based on the second edge metric value. The method 700 at 716 includes generating a graph neural network (GNN) (e.g., first GNN 304 of FIG. 3) configured to generate first prediction data for a first time, based on the graph data structure that includes the first node, the second node, the third node, the fourth node, the undirected edge, and the directed edge. A temporal graph neural network (TGNN) (e.g., second GNN 306 of FIG. 3) configured to generate second prediction data for a second time that is after the first time is generated at 718 based on the graph data structure.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

1-12. (canceled)

13. A method, comprising:
receiving input data;
providing the input data as input to an encoder model to produce a semantic vector;
providing the semantic vector as input to a first graph neural network to produce, based on a first aggregation value, first prediction data for a first time, the first graph neural network including a graph data structure that has (1) a directed edge having a correlation weight and (2) an undirected edge having a causal weight, and the first graph neural network being configured to generate the first aggregation value (1) based on a plurality of weight values associated with a plurality of nodes of the graph data structure and (2) not based on a temporal dependency; and
providing the semantic vector as input to a second graph neural network to produce, based on a second aggregation value, second prediction data for a second time after the first time, the second graph neural network being produced based on the graph data structure and configured to generate the second aggregation value based on (1) the plurality of weight values and (2) the temporal dependency.

14. The method of claim 13, wherein:
the plurality of nodes represents a plurality of features that is associated with a plurality of datasets;
the correlation weight is determined based on a first pair of features from the plurality of features; and
the causal weight is determined based on a second pair of features different from the first pair of features and from the plurality of features.

15. The method of claim 13, wherein:
the plurality of nodes represents a plurality of features that is associated with a plurality of datasets;
the correlation weight is determined based on a first pair of features from the plurality of features, a covariance metric value associated with the plurality of features and a standard deviation associated with the plurality of features; and
the causal weight is determined based on a second pair of features different from the first pair of features and from the plurality of features.

16. The method of claim 13, wherein:
the plurality of nodes represents a plurality of features that is associated with a plurality of datasets;
the correlation weight is determined based on a first pair of features from the plurality of features; and
the causal weight is determined based on (1) a second pair of features different from the first pair of features and from the plurality of features, and (2) by performing at least one of a Granger causality test or structural equation modelling, based on the plurality of features.

17. The method of claim 13, further comprising:
receiving incomplete input data from a user compute device; and
providing the incomplete input data to at least one of a mean imputation model or a regression imputation model, to produce the input data.

18-20. (canceled)

21. The method of claim 13, wherein:
the second graph neural network includes a temporal graph neural network (TGNN) configured to produce the second prediction data for the second time after the first time.

22. The method of claim 13, wherein:
the second graph neural network is modified from the first graph neural network to facilitate temporal message passing.

23. A non-transitory, processor-readable medium storing instructions that, when executed by a processor, cause the processor to:
receive input data;
provide the input data as input to an encoder model to produce a semantic vector;
provide the semantic vector as input to a first graph neural network to produce, based on a first aggregation value, first prediction data for a first time, the first graph neural network including a graph data structure that has (1) a directed edge having a correlation weight and (2) an undirected edge having a causal weight, and the first graph neural network being configured to generate the first aggregation value (1) based on a plurality of weight values associated with a plurality of nodes of the graph data structure and (2) not based on a temporal dependency; and
provide the semantic vector as input to a second graph neural network to produce, based on a second aggregation value, second prediction data for a second time after the first time, the second graph neural network being produced based on the graph data structure and configured to generate the second aggregation value based on (1) the plurality of weight values and (2) the temporal dependency.

24. The non-transitory, processor-readable medium of claim 23, wherein:
the plurality of nodes represents a plurality of features that is associated with a plurality of datasets;
the correlation weight is determined based on a first pair of features from the plurality of features; and
the causal weight is determined based on a second pair of features different from the first pair of features and from the plurality of features.

25. The non-transitory, processor-readable medium of claim 23, wherein:
the plurality of nodes represents a plurality of features that is associated with a plurality of datasets;
the correlation weight is determined based on a first pair of features from the plurality of features, a covariance metric value associated with the plurality of features and a standard deviation associated with the plurality of features; and
the causal weight is determined based on a second pair of features different from the first pair of features and from the plurality of features.

26. The non-transitory, processor-readable medium of claim 23, wherein:
the plurality of nodes represents a plurality of features that is associated with a plurality of datasets;
the correlation weight is determined based on a first pair of features from the plurality of features; and
the causal weight is determined based on (1) a second pair of features different from the first pair of features and from the plurality of features, and (2) by performing at least one of a Granger causality test or structural equation modelling, based on the plurality of features.

27. The non-transitory, processor-readable medium of claim 23, further storing instructions to cause the processor to:
receive incomplete input data from a user compute device; and
provide the incomplete input data to at least one of a mean imputation model or a regression imputation model, to produce the input data.

28. The non-transitory, processor-readable medium of claim 23, wherein:
the second graph neural network includes a temporal graph neural network (TGNN) configured to produce the second prediction data for the second time after the first time.

29. The non-transitory, processor-readable medium of claim 23, wherein:
the second graph neural network is modified from the first graph neural network to facilitate temporal message passing.

30. An apparatus, comprising:
a processor; and
a memory operably coupled to the processor and storing instructions to cause the processor to:
receive input data,
provide the input data as input to an encoder model to produce a semantic vector,
provide the semantic vector as input to a first graph neural network to produce, based on a first aggregation value, first prediction data for a first time, the first graph neural network including a graph data structure that has (1) a directed edge having a correlation weight and (2) an undirected edge having a causal weight, and the first graph neural network being configured to generate the first aggregation value (1) based on a plurality of weight values associated with a plurality of nodes of the graph data structure and (2) not based on a temporal dependency, and
provide the semantic vector as input to a second graph neural network to produce, based on a second aggregation value, second prediction data for a second time after the first time, the second graph neural network being produced based on the graph data structure and configured to generate the second aggregation value based on (1) the plurality of weight values and (2) the temporal dependency.

31. The apparatus of claim 30, wherein:
the plurality of nodes represents a plurality of features that is associated with a plurality of datasets;
the correlation weight is determined based on a first pair of features from the plurality of features; and
the causal weight is determined based on a second pair of features different from the first pair of features and from the plurality of features.

32. The apparatus of claim 30, wherein:
the plurality of nodes represents a plurality of features that is associated with a plurality of datasets;
the correlation weight is determined based on a first pair of features from the plurality of features, a covariance metric value associated with the plurality of features and a standard deviation associated with the plurality of features; and
the causal weight is determined based on a second pair of features different from the first pair of features and from the plurality of features.

33. The apparatus of claim 30, wherein:
the plurality of nodes represents a plurality of features that is associated with a plurality of datasets;
the correlation weight is determined based on a first pair of features from the plurality of features; and
the causal weight is determined based on (1) a second pair of features different from the first pair of features and from the plurality of features, and (2) by performing at least one of a Granger causality test or structural equation modelling, based on the plurality of features.

34. The apparatus of claim 30, wherein the memory further stores instructions to cause the processor to:
receive incomplete input data from a user compute device; and
provide the incomplete input data to at least one of a mean imputation model or a regression imputation model, to produce the input data.

35. The apparatus of claim 30, wherein:
the second graph neural network is modified from the first graph neural network to facilitate temporal message passing.
